(19) United States
(12) Patent Application Publication
(10) Pub. No.: US 2009/0257401 A1
(43) Pub. Date: Oct. 15, 2009

(54) COMMUNICATION SYSTEM, MOBILE ROUTER AND HOME AGENT

(75) Inventors: Jun Hirano, Kanagawa (JP); Chan Wah Ng, Singapore (SG); Tien Ming Benjamin Koh, Singapore (SG); Chun Keong Benjamin Lim, Singapore (SG); Pek Yew Tan, Singapore (SG)

Correspondence Address: Dickinson Wright PLLC;James E. Ledbetter, Esq., International Square, 1875 Eye Street, N.W., Suite 1200, Washington, DC, 20006, US

(73) Assignee: Panasonic Corporation, OSAKA (JP)

(21) Appl. No.: 12/439,530

(22) PCT Filed: Sep. 5, 2007
(86) PCT No.: PCT/JP2007/067694

§ 371 Date: Feb. 28, 2009

(30) Foreign Application Priority Data
Sep. 6, 2006 (JP) 2006-241644

(51) Int. Cl. H04W 36/00

(52) U.S. Cl. 370/331

(57) ABSTRACT

The present invention provides a new technique, according to which inefficient and redundant routing can be eliminated, which may occur when the fast handover is applied to network mobility and which may cause delay. According to this technique, a mobile router (MR) 210 makes the mobile node grasp the care-of address of the mobile router by performing route optimization to and from the mobile node (MN) 130 connected to the mobile network under its control. When the mobile node performs handover to another access network by fast handover, the mobile router tunnels a packet by using own care-of address as a source address—i.e. the packet, which has been sent from a correspondent node (CN) 140 and which is to be sent to an address before the handover of the mobile node (old care-of address)—and the packet is directly forwarded to the mobile node without passing through the home agent of the mobile router.

### TECHNICAL FIELD

The present invention relates to a packet-switched data communication network in a communication field. In particular, the invention relates to a communication system including a mobile node to execute fast handover procedure in a mobile network, to a mobile router, and to a home agent of the mobile router.

### BACKGROUND ART

Currently, a multiple of mobile devices are performing communication with each other by using IP (Internet Protocol) network. For the purpose of providing mobility support to the mobile devices, IETF (Internet Engineering Task Force) is working on the extension of the mobility support in IPv6 (Internet Protocol version 6). In the mobile IP, each mobile node has a permanent home domain. In case the mobile node is connected to its own home network, a primary global address generally known as a home address (HoA) is assigned to the mobile node.

On the other hand, when a mobile node is away from the home network, i.e. when a mobile node is connected to a foreign network, a temporary global address known as a care-of address (CoA) is assigned to the mobile node. Basic concept of the mobility support is that the mobile node can be reached by its own home address even when the mobile node is connected to a foreign network.

This concept can be actualized by introducing an entity, which is known as a home agent (HA), into the home network. According to the Non-Patent Document 1, the mobile node registers the care-of address to the home agent by using a message, which is known as a binding update (BU) message. In so doing, the home agent can generate a binding between the home address and the care-of address of the mobile node. The home agent intercepts a message directed to the home address of the mobile node and forwards a packet to the care-of address of the mobile node by encapsulating the packet (i.e. by turning a packet to a payload of a new packet, and this is also known as packet tunneling).

This is a simple mechanism, while there are problems in its performance characteristics. One of the problems relates to the delay from the mobile node changing its point of attachment to the time the home agent receives the binding update message which notifies the change of the point of attachment. During this time period, the packet intercepted by the home agent is forwarded to a previous or old care-of address, which the mobile node has been using up to the moment immediately before the change of the point of attachment. As a result, the packet would be lost.

In view of this point, IETF developed a fast handover solution relating to MIPv6 (FMIPv6). Description will be given below on an example of FMIPv6.

FIG. 1A shows a network arrangement to explain the prior art relating to FMIPv6. A mobile node (MN 130) is moving between two access routers AR 110 and AR 112 in order to gain access to a global communication network 100 such as Internet. HA 120 is a home agent of MN 130, and CN 140 is a correspondent node that communicates with MN 130.

FMIPv6 has two modes: reactive mode and predictive mode. In the reactive mode, the mobile node recognizes that handover procedure should be performed after the connection with an access router has been cut off, to which it has been connected up to the moment immediately before the handover (a previous or old access router). On the other hand, in the predictive mode, the mobile node attempts to change the point of attachment when a new access router to be connected is discovered by the handover.

FIG. 1B shows a message sequence according to the predictive mode of FMIPv6. Here, AR 110 is an old access router and AR 112 is a new access router. MN 130 discovers the new access router AR 112 in a process 150 and sends a fast binding update (FBU) message 152 to a current access router AR 110. By the FBU message 152, the interrelation with the old care-of address and the new care-of address of MN 130 is notified to AR 110. After the FBU message 152 has been received, AR 110 proceeds to send a handover initiation (HI) message 154 to the new access router AR 112 in order to verify whether the new care-of address can be used or not. AR 112 responds to the HI message 154 by sending a Handover Acknowledgement (HAck) message 156. After receiving the HAck message 156, AR 110 gives approval to the FBU message 152 by sending a Fast Binding Acknowledgement (FBack) message 158. Thereafter, AR 110 forwards the packet sent to the old care-of address of MN 130 to AR 112.

This is shown by the transmission of a data packet 160 to MN 130 by CN 140. The home agent HA 120 intercepts the data packet 160 and tunnels it to the old care-of address of MN 130. This is shown by a tunnel packet 162. Upon receipt of this tunnel packet 162, AR 110 forwards it to AR 112 (as shown by a packet 164). Because MN 130 is not yet connected to AR 112, the forwarded packet 164 is buffered by AR 112 as shown in a process 166.

When MN 130 is connected to AR 112, a Fast Neighbor Advertisement (FNA) message 170 is sent to the new access router 112. The handover procedure is now completed. AR 112 can now forward the buffered packet to MN 130 (as shown by a packet 172). Further, MN 130 sends a binding update (BU) message 174 to its own home agent and updates HA 120 to match the change of the care-of address.

FIG. 1C shows a message sequence according to the reactive mode of FMIPv6. Here, AR 110 is an old access router and AR 112 is a new access router. In a process 180, MN 130 discovers that the connection with the old access router AR 110 has been disconnected and that the new access router is AR 112 and proceeds to send a FNA message 182 to AR 112. MN 130 encapsulates the FBU message 184 in the FNA message 182 and sends it to the old access router AR 110. Binding is set up at the old access router AR 110 so that AR 110 can forward the packet directed to the old care-of address of MN 130 to the new care-of address.

This is shown by the transmission of a data packet 188 to MN 130 by CN 140. The home agent 120 intercepts the data packet 188 and tunnels it to the old care-of address of MN 130. This is indicated by a tunnel packet 190. Upon receipt of this tunnel packet 190, AR 110 forwards it to the new care-of address of MN 130 via AR 112 (as shown by the packets 192 and 194). Then, MN 130 sends a binding update (BU) message 196 to its own home agent and updates HA 120 to match the change of the care-of address.

One of the advantageous points of FMIPv6 is that a packet delivered to the old care-of address of the mobile node can be delivered to the new care-of address of the mobile node. In the Patent Document 1 given below, a method is described, in which the old access router or the new access router conveys additional information to the old access network or the new access network to speed up the handover procedure. This type of information is used for the purpose that an arbitrary decision can be made in advance, and this makes it possible to speed up the handover procedure. However, in both of FMIPv6 and the method of the Patent Document 1, new functions are required for both of the old access router and the new access router.

In the Patent Document 2 as given below, a method is described, according to which, when the old access router or the new access router does not support the functions of FMIPv6, the home agent is used instead.

However, according to the solution of the Patent Document 2, further delay may be caused due to the tunnel established by Network Mobility (NEMO) basic support when the mobile node moves to the inside or the outside of the mobile network. Basically, the network mobility is an extension of the concept of the mobility support on each individual host to the mobility support on the network of the node (see the Patent Documents 3 and 4 and the Non-Patent Document 3 as given below). In this case, the mobile router for managing the mobile network establishes a bi-directional tunnel to the home agent by sending a binding update message to the home agent. The binding update message designates a network prefix by using a special option known as a network prefix option.

By the technique as described above, the home agent can prepare a routing table of prefixes and the packet to be sent to destinations with these prefixes can be forwarded to the care-of address of the mobile router. This means that the packet directed to the mobile network is intercepted by the home agent and is forwarded to the mobile router via the tunnel. The mobile router sends the packet to a host in the mobile network. In case a node in the mobile network sends a packet to outside of the mobile network, the mobile node intercepts the packet and forwards it to the home agent via the tunnel. Then, the home agent sends the packet to a receiver as desired.

### [Patent Document 1] European Patent Application Publication No. 1524814

### [Patent Document 2] European Patent Application Publication No. 1643693

[Patent Document 3] U.S. Pat. No. 6,636,498

### [Patent Document 4] U.S. Application Publication No. 2003-0117965

### [Non-Patent Document 1] Johnson, D. B., Perkins, C. E., and Arkko, J., “Mobility Support in IPv6”, Internet Engineering Task Force Request For Comments 3775, June 2004.

### [Non-Patent Document 2] Koodli, R., et. al., “Fast Handovers for Mobile IPv6”, Internet Engineering Task Force Request For Comments 4068, July 2005.

### [Non-Patent Document 3] Devarapalli, V., et. al., “NEMO Basic Support Protocol”, Internet Engineering Task Force Request For Comments 3963, January 2005.

With the introduction of the mobile network, the mobile node using FMIPv6 may carry out handover procedure between the access router and the mobile router. When the mobile router fulfills the functions of FMIPv6 access routers, this leads to a partially optimized state as explained below. Specifically, when the mobile router executes the functions as described in FMIPv6, redundant path to cause delay may occur as shown in FIG. 2B and FIG. 2C.

FIG. 2A shows an example of network arrangement. A mobile node (MN 130) is roaming between an access router AR 110 and a mobile router MR 210 in order to gain access to a global communication network 100 such as Internet. HA 120 is a home agent of MN 130, and HA 220 is a home agent of the mobile router MR 210. CN 140 is a correspondent node to perform communication at MN 130.

FIG. 2B shows a routing of a data packet sent from CN 140 to MN 130 when MN 130 moves into a mobile network 200. FIG. 2C shows a routing taken by a data packet sent from CN 140 to MN 130 when MN 130 moves to outside of the mobile network 200.

In FIG. 2B, the mobile node MN 130 moves into the mobile network. That is, MR 210 is a new access router, and AR 110 is an old access router. When a FBU message is sent to AR 110, a packet to be sent to the old care-of address of MN 130 may have further delay until it reaches the new care-of address of MN 130. This is shown in FIG. 2B by a data packet sent from CN 140 to MN 130.

As shown by a path 240, the packet first reaches the home network of MN 130 and is intercepted by HA 120. As shown by a path 242, HA 120 forwards the packet to the old care-of address of MN 130. Then, AR 110 forwards the packet to the new care-of address of MN 130 (i.e. an address configured by a mobile network prefix of the mobile network 200). Therefore, as shown by a path 244, the packet is intercepted by HA 220. Then, HA 220 forwards the packet to MR 210 via the bi-directional tunnel as shown by a path 246. Finally, MR 210 decapsulates the packet and forwards the original data packet to MN 130 via a path 248. In this way, the data packet takes very long path, and the delay is caused. As a result, this invalidates the purpose to execute the fast handover.

In FIG. 2C, the mobile node MN 130 moves outside from the mobile network 200. That is, MR 210 is an old access router and AR 110 is a new access router. When a FBU message is sent to MR 210, a packet sent to the old care-of address of the mobile node may be further delayed until it reaches the new care-of address of MN 130. In FIG. 2C, this is shown by the data packet to be sent from CN 140 to MN 130.

As shown by a path 260, the packet first reaches the home network of MN 130 and is intercepted by HA 120. HA 120 forwards the packet to the old care-of address of MN 130. However, the old care-of address is sent to HA 220 as shown by a path 262 because the old care-of address is configured with a prefix of the mobile network 200. Then, HA 220 sends this packet to MR 210 as shown by a path 264. Upon receipt of a FBU message from MN 130, MR 210 forwards the packet to the new care-of address of MN 130. For this purpose, MR 210 must send the packet to its own home agent via a bi-directional tunnel. This is shown in a path 266. HA 220 decapsulates the packet and forwards it to AR 110 as shown by a path 268. Finally, AR 110 forwards the packet to MN 130 via a path 270.

### DISCLOSURE OF THE INVENTION

As indicated in the examples given above, the support of FMIPv6 in the network mobility is inefficient and roundabout, and this causes further delay, and this is not allowable for the use as an application, which requires the effect of the fast handover. To solve the above problems, it is an object of the present invention to reduce and eliminate inefficient and redundant routing, which may occur when the fast handover procedure is applied to the network mobility and which may cause delay.

To attain the above object, the present invention provides a communication system including a mobile router, said mobile router having a home address managed by a predetermined home agent and a care-of address depending on moving position, said mobile router implementing a mobility function with a mobile network where a mobile node can connect under the control, and said mobile router being capable of fulfilling function as an access router of said mobile node to execute fast handover, wherein:

said mobile node is connected to said mobile router immediately before or immediately after said fast handover, and when a packet addressed to said mobile node is forwarded via two access routers connected immediately before or immediately after said fast handover including said mobile router, said packet is forwarded so that said packet does not pass through a tunnel between said mobile router and said predetermined home agent of said mobile router.

With the arrangement as described above, it is possible to reduce and eliminate inefficient and redundant routing, which may occur when the fast handover procedure is applied in the network mobility and which may cause delay.

Also, the present invention provides a mobile router having a home address managed by a predetermined home agent and a care-of address depending on moving position, said mobile router implementing a mobility function with a mobile network where a mobile node can connect under the control, and said mobile router being capable of fulfilling function as an access router of said mobile node to execute fast handover, wherein said mobile router comprises:

means for clarifying the validity of said care-of address of said mobile router to said mobile node in said mobile network; and

means for using own care-of address as a source address before forwarding a packet to said mobile node when said mobile node performs said fast handover to another access network from said mobile network.

With the arrangement as described above, it is possible to reduce and eliminate inefficient and redundant routing, which may occur when the fast handover procedure is applied in the network mobility and which may cause delay.

Further, the present invention provides the mobile router as described above, wherein said means for clarifying the validity of said care-of address is so arranged that route optimization procedure is carried out to and from said mobile node in said mobile network.

With the arrangement as described above, it is possible to clarify that the care-of address of the mobile router is proper and just for the mobile node in the mobile network and to use the care-of address of the mobile router as the source address or the destination address of the packet to be sent to or received from the mobile node.

Also, the present invention provides the mobile router as described above, wherein said means for clarifying the validity of said care-of address is so arranged that the validity of said care-of address is clarified to said mobile node, which sends a fast binding update message in said fast handover.

With the arrangement as described above, a mobile router can clearly indicate the validity of the care-of address to the mobile node so that the mobile router can perform predictive fast handover at an adequate timing.

Further, the present invention provides the mobile router as described above, wherein said means for clarifying the validity of said care-of address is so arranged that said mobile node for clarifying the validity of said care-of address is selected.

With the arrangement as described above, the mobile router can select only a mobile node, for which the validity of the care-of address can be clarified among a plurality of mobile nodes connected under its control.

Also, the present invention provides the mobile router as described above, wherein said means for clarifying the validity of said care-of address is so arranged that said care-of address is inserted in a message to be notified to said mobile network from said mobile router.

With the arrangement as described above, the mobile router can notify its own care-of address and the validity by a router advertisement message, for instance.

Further, the present invention provides the mobile router as described above, wherein said means for clarifying the validity of said care-of address is so arranged that encrypted information is exchanged to and from said mobile node in said mobile network in order to verify the validity of said care-of address.

With the arrangement as described above, the encrypted information can be correctly encrypted and decrypted, and it is possible to verify the validity of the care-of address of the mobile router.

Also, to attain the above object, the present invention provides a mobile router having a home address managed by a predetermined home agent and a care-of address depending on moving position, said mobile router implementing a mobility function with a mobile network where a mobile node can connect under the control, and said mobile router being capable of fulfilling function as an access router of said mobile node to execute fast handover, wherein said mobile router comprises:

means for clarifying the validity of said care-of address owned by said mobile router itself to an access router, to which said mobile node has been connected before said fast handover; and

means for using own care-of address as a source address when a packet addressed to said mobile node is forwarded in case said mobile node performs said fast handover to said mobile network from another access network under management of said access router, to which said mobile node has been connected before said fast handover.

With the arrangement as described above, it is possible to reduce and eliminate inefficient and redundant routing, which may occur when the fast handover procedure is applied in the network mobility and which may cause delay.

Further, the present invention provides the mobile router as described above, wherein said means for clarifying the validity of said care-of address is so arranged that route optimization procedure is carried out to and from said access router, to which said mobile node has been connected before said fast handover.

With the arrangement as described above, it is possible to clarify that the care-of address of the mobile router is proper and just to an access router, to which the mobile node has been connected before the fast handover, and also to use the care-of address of the mobile router as the source address or the destination address of the packet to be sent or received via the access router.

Also, the present invention provides the mobile router as described above, wherein said means for clarifying the validity of said care-of address is so arranged that the validity of said care-of address is clarified to said access router sending said handover initiation message when the handover initiation message in said fast handover is received.

With the arrangement as described above, the mobile router can clarify the validity of the care-of address to the access router, to which the mobile node has been connected before the fast handover, at an adequate timing to perform fast handover by the mobile node.

Further, the present invention provides the mobile router as described above, wherein said means for clarifying the validity of said care-of address is so arranged that the validity of said care-of address is clarified to said access router where said mobile node sending said fast neighbor advertisement message has been connected before said fast handover when a fast neighbor advertisement message in said fast handover is received.

With the arrangement as described above, the mobile router can clarify the validity of the care-of address to an access router, to which the mobile node has been connected before the fast handover at such an adequate timing that the mobile node performs reactive fast handover.

Also, the present invention provides the mobile router as described above, wherein said means for clarifying the validity of said care-of address is so arranged that a predetermined message is exchanged to and from said access router where said mobile node has been connected before said fast handover in order to verify the validity of said care-of address.

With the arrangement as described above, the mobile router can clarify the validity of the care-of address to an access router without mobility functions by using a message, which can be handled by an access router without mobility functions as a message.

Further, to attain the above object, the present invention provides a home agent managing a home address and a care-of address of a mobile router, said mobile router implementing a mobility function with a mobile network where a mobile node can connect under the control, and said mobile router being capable of fulfilling function as an access router of said mobile node to execute fast handover, wherein said home agent comprises:

means for storing a binding of a care-of address of said mobile node under the condition where said mobile node is connected to said mobile network and a care-of address of said mobile node in a new access network where said mobile node is connected by said fast handover; and

means for forwarding a packet, which is addressed to the care-of address of said mobile node under the condition where said mobile node is connected to said mobile network, said packet to be forwarded to the care-of address of said mobile node in said new access network.

With the arrangement as described above, the home agent of the mobile router can forward a packet directly to an access router after the mobile node has moved by the fast handover without forwarding the packet addressed to the mobile node by using a tunnel to the mobile router. As a result, inefficient and redundant routing can be eliminated, which may occur when the fast handover is applied to the network mobility and which may cause delay.

The present invention provides such effects that inefficient and redundant routing can be eliminated, which may occur when the fast handover is applied to network mobility and which may cause delay. Also, the invention has such effects that inefficient and redundant routing to cause delay can be reduced and eliminated by designing that a packet directed to the mobile node is not sent via a bi-directional tunnel established between the mobile router and the home agent of the mobile router when the mobile node performs the fast handover between two access routers, of which at least one is a mobile router.

### BRIEF DESCRIPTION OF THE DRAWINGS

FIG. 1A is a schematical drawing to show an example of network arrangement to explain the prior art;

FIG. 1B is a sequence chart to show a case where predictive fast handover is performed between an access router and a mobile node in the prior art;

FIG. 1C is a sequence chart to show a case where reactive fast handover is performed between a mobile node and an access router in the prior art;

FIG. 2A is a schematical drawing to show an example of network arrangement to explain the difference between an embodiment of the present invention and the prior art;

FIG. 2B is a schematical drawing to show an example of a packet transmission routing in case the mobile router (MR) is a new access router in FIG. 2A in the prior art;

FIG. 2C is a schematical drawing to show an example of a packet transmission routing in case MR is an old access router in FIG. 2A in the prior art;

FIG. 3A is a sequence chart to show a case where route optimization procedure is performed between a mobile router and a mobile node when the mobile node performs handover procedure from a mobile router to an access router in the embodiment of the invention;

FIG. 3B is a sequence chart to show a case where route optimization procedure is performed between a mobile router and a mobile node when the mobile node performs handover procedure from a mobile router to an access router in the embodiment of the invention;

FIG. 4 is a sequence chart to show a case where validity of a care-of address of the mobile router is clarified to the mobile node when a mobile node performs handover procedure from a mobile router to an access router in the embodiment of the invention;

FIG. 5 is a sequence chart to show a case where packet forwarding route is optimized under the support of the home agent of the mobile router when the mobile node performs handover procedure from the mobile router to the access router in the embodiment of the invention;

FIG. 6A is a sequence chart to show a case where route optimization procedure is performed between an old access router and a new access router (mobile router) when the mobile node performs predictive fast handover from the access router to the mobile router in the embodiment of the invention;

FIG. 6B is a sequence chart to show a case where route optimization procedure is performed between an old access router and a new access router (mobile router) when the mobile node performs reactive fast handover from the access router to the mobile router in the embodiment of the invention;

FIG. 7A is a sequence chart to show a case where optimization using ping is performed when the old access router does not correspond to a standard route optimization processing in case the mobile node performs predictive fast handover from the access router to the mobile router in the embodiment of the invention;

FIG. 7B is a sequence chart to show a case where optimization using ping is performed when the old access router does not correspond to a standard route optimization processing in case the mobile node performs reactive fast handover from the access router to the mobile router in the embodiment of the invention;

FIG. 8 is a block diagram to show an example of functional architecture of a mobile router in the embodiment of the invention;

FIG. 9 is a flow chart to show an example of a mobile router when a FBU message is received in the embodiment of the invention;

FIG. 10 is a flow chart to show an example of a mobile router when a FNA message is received in the embodiment of the invention;

FIG. 11 is a flow chart to show an example of a mobile router when a HI message is received in the embodiment of the invention; and

FIG. 12 is a schematical drawing to show an example of network arrangement where local mobility management is provided in the embodiment of the invention.

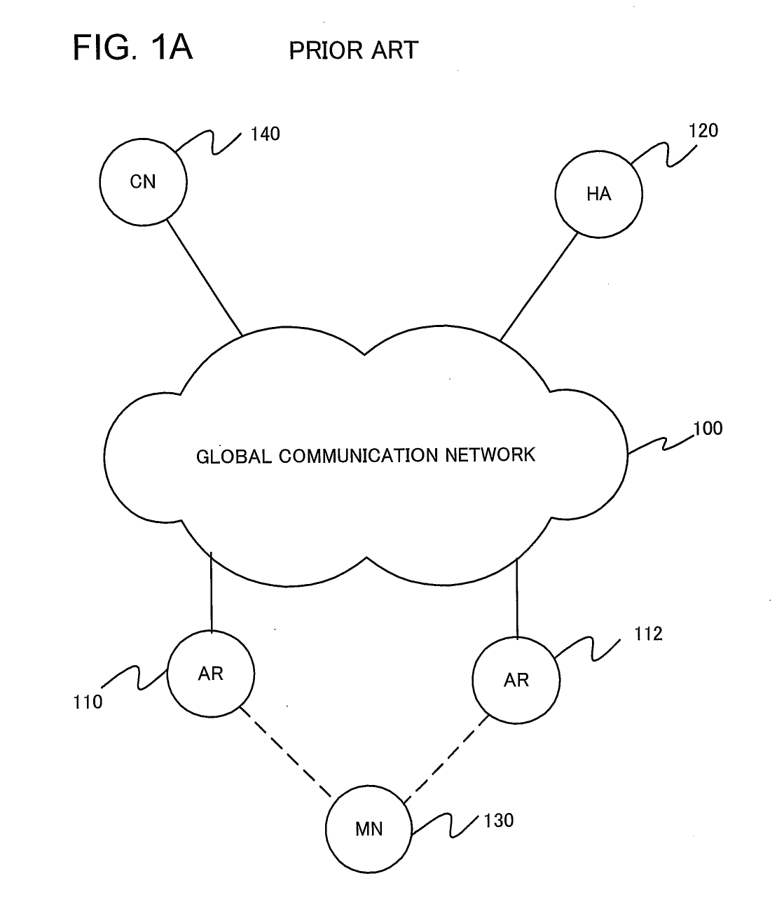

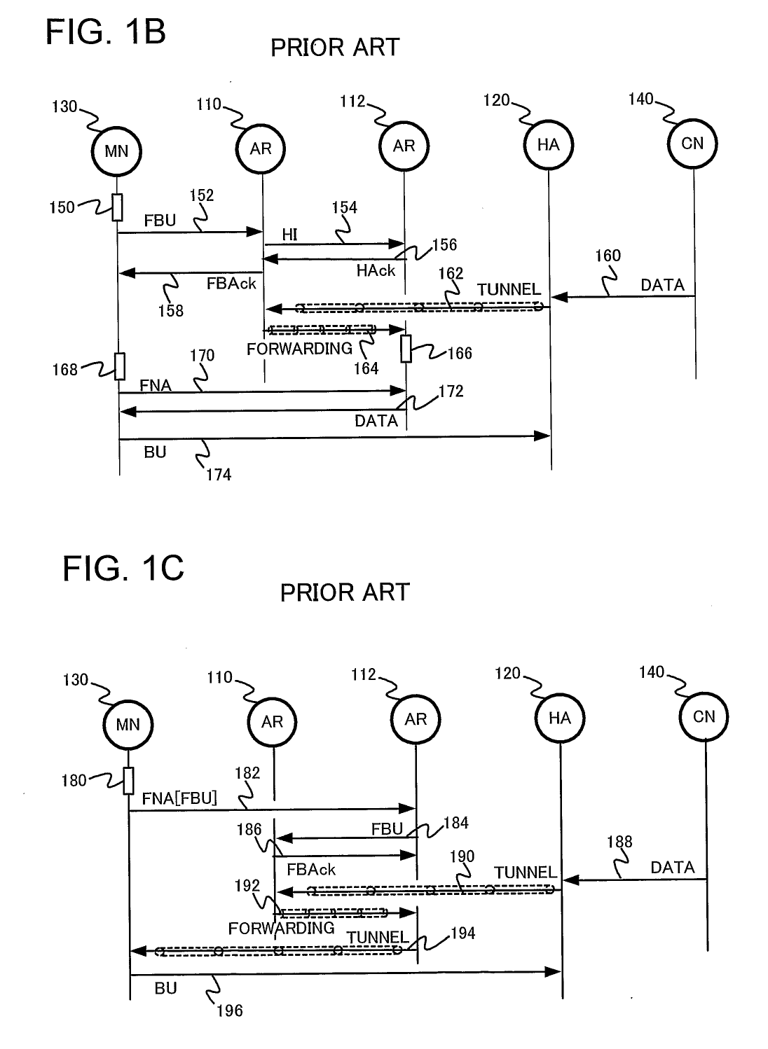

### BEST MODE FOR CARRYING OUT THE INVENTION

Description will be given below on an embodiment of the present invention referring to the attached drawings. The present invention relates to the offering of the services of fast mobile IP (FMIP) in a mobile network.

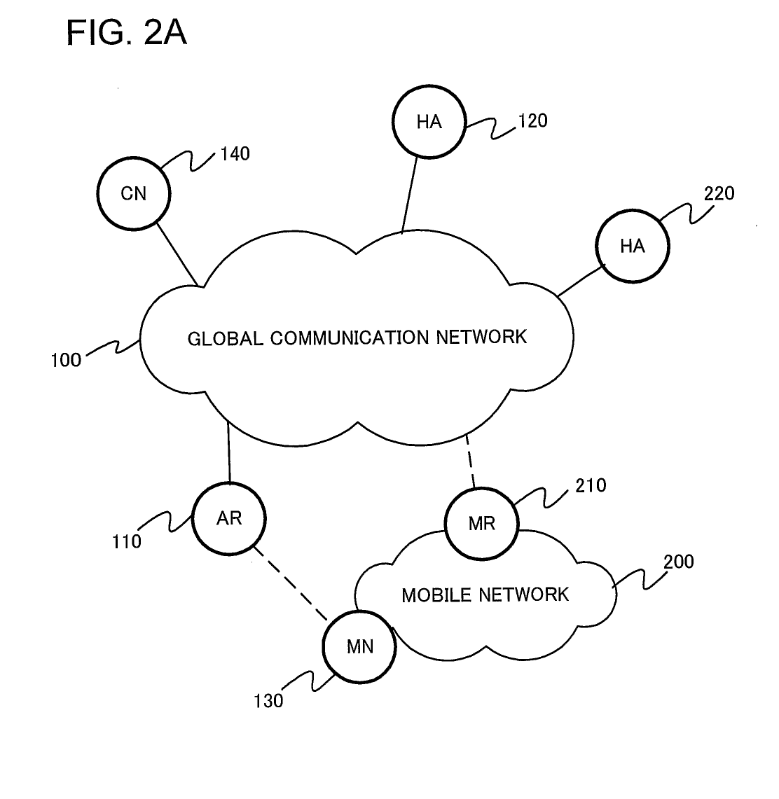

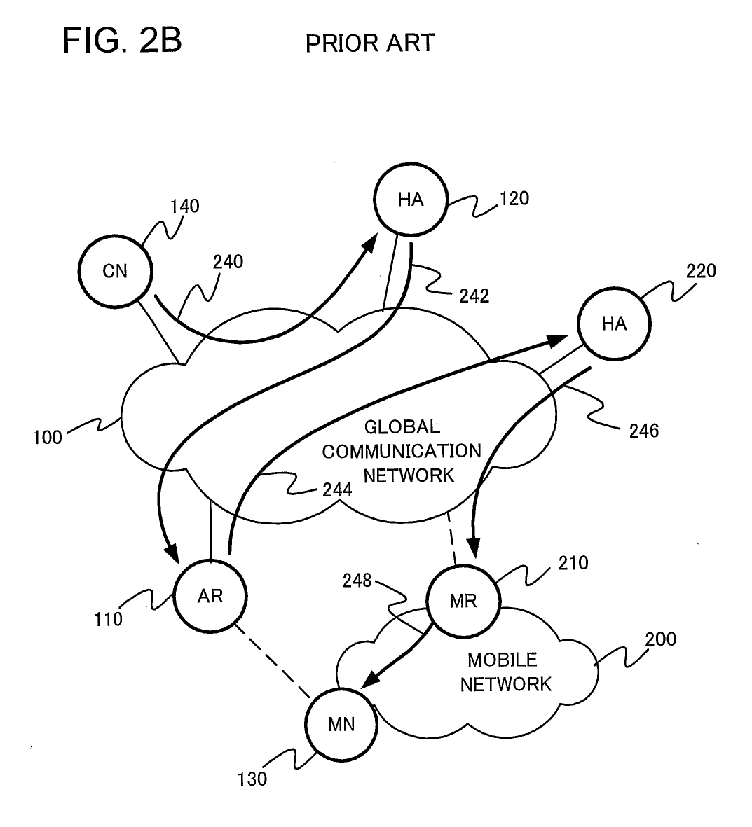

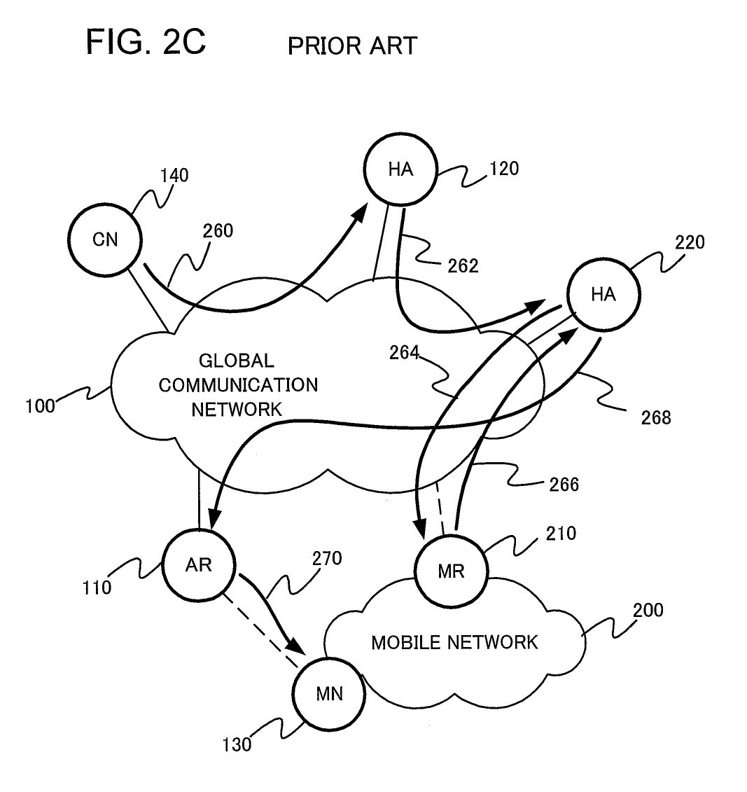

First, referring to an example of arrangement shown in FIG. 2A, description will be given on the present invention. In FIG. 2A, a mobile node MN 130 changes the points of attachment between an access router AR 110 and a mobile router MR 210. Also, HA 120 is a home agent of the mobile node MN 130, and HA 220 is a home agent of the mobile router MR 210.

Here, a specific arrangement example is used, while it would be obvious to those skilled in the art that other cases derived from it will be covered by the present invention. For instance, the mobile node MN 130 itself may be another mobile router or the access router AR 110 may be another mobile router.

In an aspect of the preferred embodiment of the present invention, consideration is given first on a case where the mobile node MN 130 moves away from the mobile network 200. This indicates that the mobile router MR 210 is an old or previous access router (an access router, which has been connected before the handover), and that the access router AR 110 is a new access router (an access router to be connected after the handover).

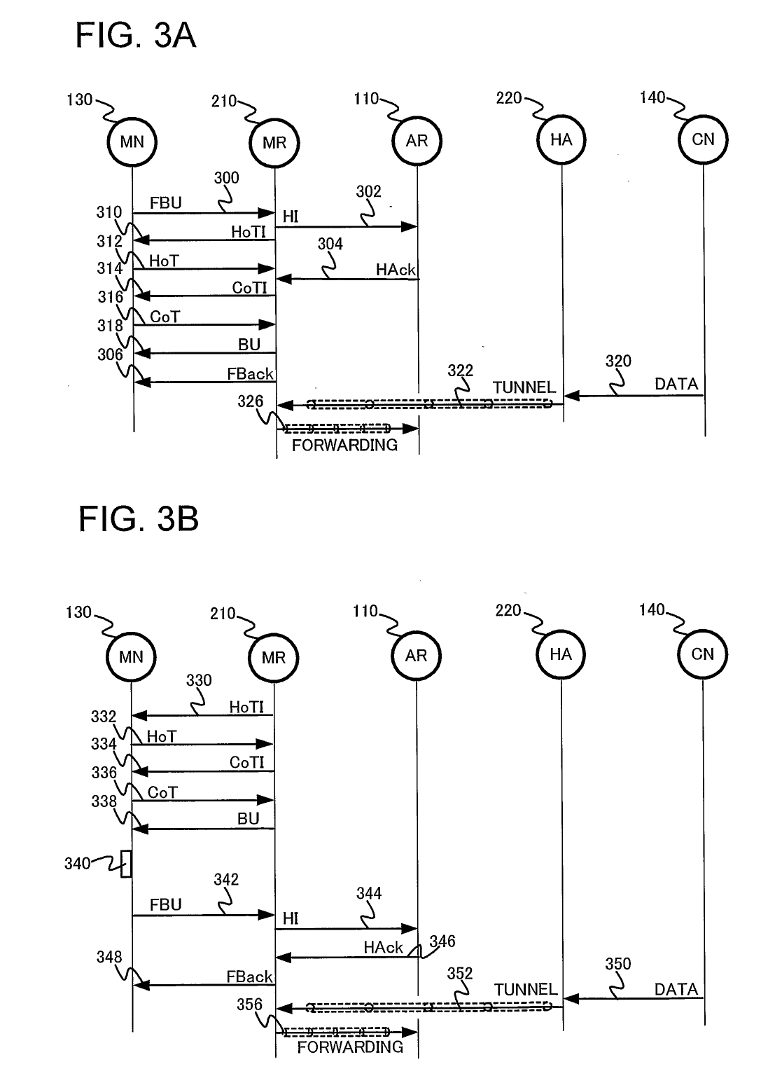

When FMIP is achieved, for the purpose of eliminating unnecessary routing or delay when a packet is forwarded, in case MR 210 forwards a packet to a new care-of address of MN 130, a processing is performed by the mobile router MR 210 to modify a route optimization (RO) of the mobile IPv6 between the mobile router MR 210 and MN 130 before changing the points of attachment by MN 130 in the preferred embodiment of the present invention. This processing is shown in FIG. 3A.

In FIG. 3A, when the need to change the point of attachment is detected, the mobile node MN 130 sends a FBU message 300 to a previous access router MR 210. Upon receipt of this FBU message 300, MR 210 sends a HI message 302 to a new access router AR 110.

Further, as shown in messages 310 to 318, MR 210 performs initial setting of MIPv6 route optimization procedure of the modified standard MIPv6 between the mobile node MN 130 and MR 210. A HoTI (Home Test Init) message 310 is to start home test, and transmission is performed by using home address of MR 210 as the source address. Normally, a packet to be sent by using home address must be tunneled to the home agent, which performs the transmission. According to the present invention, MR can send this packet to its own ingress interface. MN 130 responds with a HoT (Home Test) message 312. A cryptographic (encryption) token is included in it, and it is sent to the home address of MR 210.

Further, MR 210 sends a CoTI (Care-of Init) message 314 with the care-of address of MR 210 set on it as the source address. Normally, the packet to be sent with the care-of address set on it is sent via egress interface of MR 210. According to the present invention, MR can send this packet to its own ingress interface. MN 130 responds with a CoT (Care-of Init) message 316. A cryptographic token is included in it, and it is sent to the care-of address of MR 210.

According to the prior art on the NEMO basic support, a packet to be sent by a mobile node in a mobile network must be tunneled to HA 220, which performs the packet forwarding. However, in the present case, the packet is addressed to MR 210. Therefore, in the present invention, the mobile router MR 210 checks whether the packet is destined to itself or not and does not carry out the tunneling on the packet if it is addressed to itself.

In order to complete route optimization initializing procedure, MR 210 sends a BU message 318 to MN 130. As a result, the home address of MR 210 is bound to its care-of address. In the BU message 318, a checksum obtained from a token extracted from the HoT message 312 and the CoT message 316 is contained. By this, it can be verified to MN 130 that the care-of address and the home address described in the BU message 318 are actually associated with MN 130.

When the FBU message 300 has been received, MR 210 sends the HI message 302 to a new access router AR 100. AR 110 checks that the new care-of address is valid and that it is not currently used. Then, it gives response by sending a HAck message 304. Upon receipt of the HAck message 304, MR 210 sends a FBack message 306 to MN 130. The procedure of the fast handover is now completed.

Here, it is supposed that a correspondent node CN 140 sends a data to MN 130. To facilitate the explanation, it is assumed that CN 140 and MN 130 have sessions with route optimization (i.e. it is assumed that CN 140 grasps the binding of the old care-of address and the home address of MN 130). In this case, the old care-of address of MN 130 comprises a mobile network prefix of MN 210, and the data packet (the data) 320 is intercepted by HA 220. HA 220 forwards this data packet 320 to MR 210 by using a tunnel packet 322.

At the time of decapsulation, MR 210 confirms that the inner packet has the old care-of address of MN 130 as its address. As a result, MR 210 sends the packet by tunneling it to the new care-of address of MN 210 as it is indicated by the packet forwarding (326) in FIG. 3A. Because MR 210 has sent the binding of its own care-of address and home address to MN 130, it can perform the packet forwarding (326) by using route optimization mechanism. Therefore, there is no need to return the packet by tunneling to HA 220, which performs the packet forwarding. MN 130 receives the packet in case it is already connected to AR 110. Also, in case MN 130 is not yet connected to AR 110, the packet 326 is buffered by AR 110 until MN 130 is connected to AR 110.

According to the preferred embodiment of the present invention as described above, a long-winding path as shown in FIG. 2C can be eliminated. In particular, paths 266 and 268 via HA 220 are removed. The object of the present invention is attained by substituting with a direct tunnel between the care-of address of MR 210 and the new care-of address of MN 130. Those skilled in the art would easily understand that the order of messages shown in FIG. 3A is merely an example, and that some messages may not necessarily follow the order as shown.

For instance, after receiving the HAck message 304, MR 210 can send the FBack message 306 at any time. Further, the HoTI message 310 and the CoTI message 314 can be sent at the same time or in any order as desired. Actually, the HoTI message 310 and the CoTI message 314 may be sent before the receiving of the FBU message 300. This means that MR 210 can select the establishment of route optimization session between any mobile node as connected to its own mobile node and MR 210 by anticipating that the mobile node moves away from the network or that the mobile node needs the FMIP support. This procedure is shown in FIG. 3B.

As shown in FIG. 3B, MR 210 selects the starting of the route optimization procedure before it receives the FBU message from MN 130. Here, MR 210 starts the route optimization procedure by sending a HoTI message 330 and a CoTI message 334 to MN 130. As described above, MN 130 responds with a HoT message 332 and a CoT message 336. Upon receipt of the HoT message 332 and the CoT message 336, MR 210 sends a BU message 338 and registers the binding of the care-of address and the home address to MN 130.

After a time period 340, MN 130 detects the necessity to move, and by sending a FBU message 342 to MR 210, FMIP processing is started. In this case, the route optimization is already established, and MR 210 sends a HI message 344 to AR 110 and may perform only normal FMIP operation to send the FBack message 348 after the HAck message 346 has been received from AR 110. The procedure of the fast handover is now completed.

Here, it is supposed that CN 140 sends a data to MN 130. The old care-of address of MN 130 comprises a mobile network prefix of MR 210, and the data packet is intercepted by HA 220. HA 220 sends this data packet 350 to MR 210 by using a tunnel packet 352.

At the time of decapsulation, MR 210 comprehends that the inner packet has the old care-of address of MN 130 as its address. As a result, MR 210 sends the packet via tunneling to the new care-of address of MN 210 as shown by the packet forwarding (356) in FIG. 3B. Because MR 210 has already sent the binding of its own care-of address and home address to MN 130, it can perform the packet forwarding by using the route optimization mechanism. Therefore, there is no need to send back the packet via tunneling to HA 220, which performs the packet forwarding. MN 130 receives the packet in case it is already connected to AR 110. In case MN 130 is not yet connected to AR 110, the packet 356 is buffered by AR 110 until MN 130 will be connected to AR 110.

The difference between the technique disclosed in the present invention as described above and the prior art is as follows: According to the return routability processing of the mobile IPv6, the HoTI message and the HoT message are relayed via the home agent. However, according to the present invention, the receiver of the HoTI message is behind (under control of) the sender, and the return routability processing is optimized by taking advantage of such situation, and unnecessary routing caused by the return routability is deleted. Another way to look at this is that there exists a direct path between the sender and receiver, such that the HoTI message is not sent via the home network of the sender as per prior art.

In an aspect of the present invention, description is given on a more efficient fast handover method. In the previously described fast handover method, the mobile node must correspond to the standard route optimization procedure as prescribed in the mobile IPv6. However, in case the mobile node does not correspond to the route optimization procedure, another means to actualize efficient fast handover is needed. This can be provided by another aspect of the present invention to be described later in this specification.

On the other hand, if the mobile node can be changed to fulfill further functions, it would be possible to reduce the number of necessary messages. Description will be given below on another aspect of the preferred embodiment of the present invention.

Those skilled in the art would easily understand from FIG. 3A and FIG. 3B that initialization procedure of route optimization and initialization procedure of fast handover are different from each other. As a result, in case MR 210 forwards the packet to the new care-of address of MN 130, two different tunnels are formed between MR 210 and MN 130.

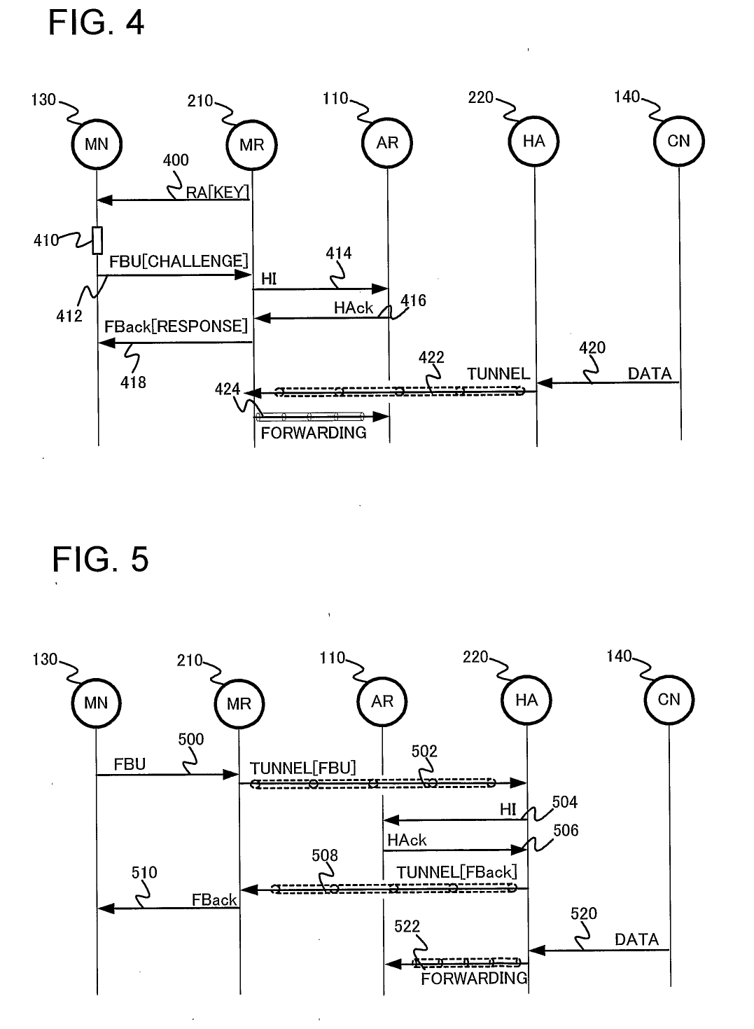

The outer tunnel is a route optimization tunnel. In this case, the source address is the care-of address of MR 210 and the destination address is the new care-of address of MN 130. On the other hand, the inner tunnel is a fast handover forwarding tunnel. Here, the source address is the home address of MR 210, and the destination address is the new care-of address of MN 130. If MN 130 is provided with new functions, the necessity to have two tunnels can be eliminated and the number of exchange message can be reduced. This is shown in FIG. 4.

According to an aspect of the present invention, the mobile router MR 210 embeds a special signal to a router advertisement (RA) message and periodically broadcasts it to its own mobile network. By this special signal, it is notified that the mobile router has the function to use the present invention to provide efficient fast handover, and the current care-of address of the mobile router is notified to the mobile node. This is shown by a RA message (RA [Key] 400 in FIG. 4.

It is preferable that this special signal is a cryptographic token generated by MR 210 such as a public key or that it is the current care-of address of MR 210. Also, it is desirable that it is inserted to the RA message 400 as a special ICMP (Internet Control Message Protocol) option.

After a time period 410, MN 130 detects the necessity to change the point of attachment and performs the processing to send a FBU message (FBU [challenge]) message 412 to MR 210. According to the present invention, the mobile node MN 130 inserts a new option including a challenge to MR 210 into the FBU message 412. Also, the FBU message 412 must be sent to the care-of address of MR 210, which is acquired from the special signal given by the RA message 400. This is carried out to check whether MR 210 can be really reached by the notified care-of address or not.

Upon receipt of the FBU message 412, MR 210 proceeds to send a HI message 414 to the new access router AR 110. Then, after receiving the response via a HAck message 416 from AR 110, MR 210 can send a FBack message (FBack [response]) 418 to MN 130. Because a challenge is included in the FBU message 412, MR 210 must insert a response to this challenge into the FBack message 418. As a result, it is clarified to MN 130 that the care-of address in the RA message 400 notified from MR 210 is valid. With the operation as described above, the fast handover procedure is completed.

Here, it is assumed that CN 140 sends a data to MN 130. Because the old care-of address of MN 130 contains a mobile network prefix of MR 210, the data packet (data) is intercepted by HA 220. Then, HA 220 sends this data packet 420 to MR 210 by using a tunnel packet 422.

At the time of decapsulation, MR 210 comprehends that the inner packet has the old care-of address of MN 130 as the address. As a result, MR 210 sends the packet by tunneling to the new care-of address of MN 210 as shown by the packet forwarding (424) in FIG. 4. Because MR 210 has already notified the validity of its own care-of address to MN 130, it can forward the packet (424) to the new care-of address of MR 130 by using its own care-of address as the source address. Therefore, there is no need to send back the packet to HA 220, which performs the packet forwarding. Further, its own home address is used as the source address, and there is no need to perform encapsulation to another route optimization tunnel by using own care-of address as the source address. MN 130 receives the packet in case it is already connected to AR 110. In case MN 130 is not connected yet to AR 110, the packet 424 is buffered by AR 110 until MN 130 is connected to AR 110.

The basic concept of the preferred embodiment of the present invention as described above is based on the establishment of the validity of the care-of address of MR 210 when the mobile router 210 and the mobile node 130 perform the exchange of some ciphers. Also, the embedding of the exchange of ciphers into another message and the reduction of the total number of necessary messages can be cited as remarkable and unique features.

In a preferred embodiment of the invention, MR 210 can notify its own care-of address and the public key via the RA message 400. In case it is necessary to start the fast handover procedure thereafter, MN 130 embeds a challenge into the message 412 and sends the care-of address of MR 210. If the address is valid, MR 210 receives the FBU message 412 and extracts the challenge and embeds a response to the challenge into the FBack message 418. Upon receipt of a correct response in the FBack message 418, MN 130 comprehends that the care-of address of MR 210 is correct. If the point of attachment has changed, the tunnel packet from this care-of address is accepted.

One of the preferable methods to provide the challenge and the response is that the challenge is encrypted by using a public key, which has been notified by MR 210 via the RA message 400. Because MR 210 has a secret key to decrypt the challenge, the challenge is received and decrypted. If this can be embedded into the FBack message 418 as a response, it is verified that MR 210 has a specific care-of address.

In the aspect of the present invention as described above, it is necessary that the mobile node MN 130 supports route optimization or it is provided with new functions explained in the present invention. However, when MN 130 does not satisfy any of these requirements, the fast handover procedure is performed by returning to the original sub-optimization state. Description will be given below on another preferred embodiment of the invention in connection with this.

Here, support is provided by the home agent of the mobile router MR 210, i.e. the support by HA 220. FIG. 5 shows a message sequence chart according to an aspect of the present invention. When a FBU message 500 is received from MN 130, MR 210 sends the FBU message to the home agent HA 220 by tunneling as a message (tunnel [FBU]) 502 as shown in FIG. 5.

Upon receipt of this FBU message, HA 220 comprehends that MR 210 needs the support to provide the fast handover to MN 130. As a result, HA 220 proceeds to send a HI message 504 to the new access router AR 110. When the access router AR 110 sends back a HAck message 506, HA 220 adds the binding table associated with the old care-of address of MN 130 and the new care-of address of MN 130 to the binding entry. Further, HA 220 prepares a FBack message to be tunneled to MR 210 shown as a message (tunnel [FBack]) 508 in FIG. 5. Then, MR 210 forwards a FBack message 510 to MN 130, and the fast handover procedure is completed.

Here, it is assumed that CN 140 sends a data to MN 130. Because the old care-of address of MN 130 contains a mobile network prefix of MR 210, the data packet (data) 520 is intercepted by HA 220. Because HA 220 has the binding of the old care-of address of MN 130 and the new care-of address of MN 130, the data packet is encapsulated by a tunnel packet 522 and it is forwarded to the new care-of address of MN 130. When MN 130 is already connected to AR 110, MN 130 receives the packet. In case MN 130 is not yet connected to AR 110, the packet 522 is buffered by AR 110 until MN 130 will be connected to AR 110.

Basic concept of the preferred embodiment of the present invention is based on the establishment of the validity of the care-of address of MR 210 through the exchange of some ciphers by the mobile router 210 and the mobile node. Also, the embedding of the exchange of the ciphers into another message or the reduction of total number of necessary messages are also regarded as remarkable and unique features.

The basic concept of the preferred embodiment of the present invention is the transfer of the processing of the old access router in FMIP from MR 210 to the home agent HA 220. As a result, there is no need to send the packet, which has been sent to the old care-of address of MN 130, by tunneling to MR 210 and it can be merely forwarded to the new access router AR 110. In so doing, the packet is directly forwarded from HA 220 to AR 110.

The embodiment of the present invention as described above is entirely different from the technique disclosed in the Non-Patent Document 2. According to the technique disclosed in the Non-Patent Document 2, in case either one of the old access router or the new access router does not correspond to FMIP, the home agent fulfills the function as the access router of the fast handover. On the other hand, according to the present invention, the home agent fulfills the function as the old access router on behalf of the mobile router in order to exclude the delay of the forwarding. Further, according to the technique disclosed in the Non-Patent Document 2, the mobile node to perform the handover requests the support to the home agent. According to the present invention, the access-router (i.e. mobile router) requests the support to its home agent.

In the preferred embodiment of the invention as described above, description has been given on the case where the mobile node MN 130 moves away from the mobile network 200, i.e. the case where MN 210 is the old access router of the fast handover. In the following, description will be given on the operation when the mobile node MN 130 moves to the mobile network 200, i.e. when MR 210 is the new access router of the fast handover.

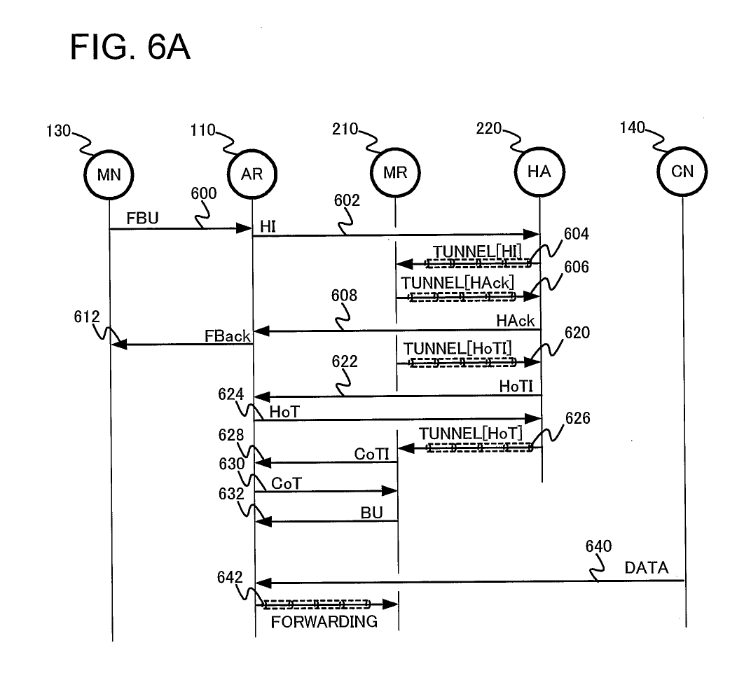

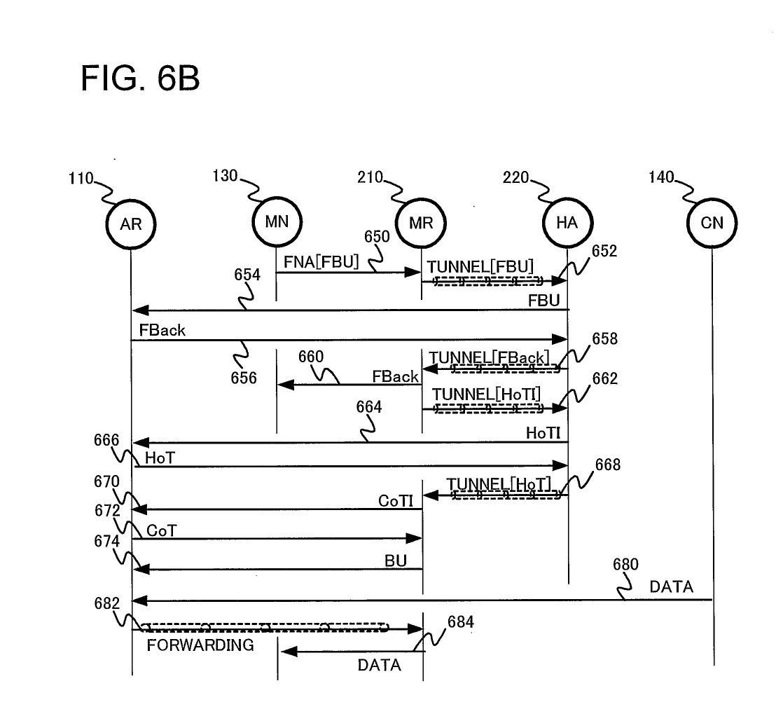

For the purpose of eliminating unnecessary routing and delay when AR 110 forwards a packet to the new care-of address of MN 130, when FMIP is realized according to a preferred embodiment of the present invention, the mobile router MR 210 executes the route optimization (RO) procedure of the standard mobile IPv6 between AR 110 and MR 210 until the completion of the fast handover. This is shown in FIG. 6A and FIG. 6B.

FIG. 6 shows a case where MN 130 performs predictive fast handover. When MN 130 detects an eminent handover, a message 600 is sent to the current access router AR 110. Upon receipt of the FBU message 600, AR 110 sends a HI message 602 to MR 210. The HI message 602 sent from AR 110 is first intercepted by HA 220. HA 220 encapsulates the HI message 602 to a tunnel packet (a tunnel [HI]) 604 and forwards it to actual position of MR 210. When this HI message is received, MR 210 responds with a HAck message 608. The HAck message 608 is encapsulated to a tunnel packet (tunnel [HAck]) 606 to be sent to HA 220 so that it is forwarded from HA 220.

According to another preferred embodiment of the invention, the mobile router MR 210 may start the route optimization procedure between AR 100 and MR 210 after receiving the HI message. This is indicated by the transmission of a HoTI message 622 and a CoTI message 628. The source address of the HoTI message 622 is the home address of the mobile route MR 210. Accordingly, it must first be tunneled to HA 220 via a tunnel packet (tunnel [HoTI]) 620. Upon receipt of the HoTI message 622, AR 110 gives response with a HoT message 624. The HoT message 624 is intercepted by HA 220 and is tunneled to MR 210 by using a tunnel packet (tunnel [HoT]) 626.

AR 110 gives response with a CoT message 630 when the CoTI message 628 is received. Upon receipt of the HoT message 624 and the CoT message 630, MR 210 can terminate the return routability procedure by sending a BU message 632 to MR 110. MR 210 preferably describes in the BU message that MR 210 handles the new care-of address of MN 130. This can be done, for instance, by describing a mobile network prefix used in the new care-of address of MN 110.

Under the condition that the route optimization has been established, when AR 110 receives a data packet 640 sent to the old care-of address of MN 130 from CN 140, AR 110 forwards this data packet via a tunnel to transmit it to the new care-of address of MN 130. This packet is further encapsulated by an outer packet 642 and is sent to the care-of address of MR 210.

FIG. 6B shows a case where MN 130 performs reactive fast handover. In this case, after MN 130 detects the execution of the handover, a FNA message (FNA [FBU]) 650 is sent to the new access router MR 210. This FNA message 650 contains an encapsulated FBU message addressed to the old access router AR 110.

Upon receipt of the FNA message 650, MR 210 forwards a FBU message 654 to AR 110. This message 654 must be forwarded from the home agent HA 220. Therefore, the FBU message 654 is first tunneled to HA 220 via a tunnel packet (tunnel [FBU]) 652. Upon receipt of the FBU message 654, AR 110 gives response with a FBack message 656. This is intercepted by HA 220 and is then forwarded to MR 210 after being encapsulated via a tunnel packet (tunnel [FBack]) 658. MR 210 decapsulates this packet 658 and forwards a FBack message 660 to MN 130.

According to another preferred embodiment of the present invention, the mobile router MR 210 can start the route optimization between AR 110 and MR 210 after sending the FBU message via the tunnel packet 652. This processing is indicated by the transmission of a HoTI message 664 and a CoTI message 670.

The HoTI message 664 must first be tunneled to HA 220 via a tunnel packet (tunnel [HoTI]) 662 because its source address is the home address of the mobile router MR 210. Upon receipt of the HoTI message 664, AR 110 gives response with a HoT message 666. This HoT message 666 is intercepted by HA 220 and is tunneled to MR 210 via a tunnel packet (tunnel [HoT]) 668.

When the CoTI message 670 is received, AR 110 gives response via a CoT message 672. Upon receipt of the HoT message 666 and the CoT message 672, MR 210 can complete return routability by sending a BU message 674 to AR 110. MR 210 preferably describes in the BU message that MR 210 handles the new care-of address of MN 130. This can be done, for instance, by describing a mobile network prefix used in the new care-of address of MN 110.

Under the condition that the route optimization is established, when AR 110 receives a data packet 680, which has been sent from CN 140 to the old care-of address of MN 130, AR 110 forwards this data packet via a tunnel packet (data) 684 to transmit it to the new care-of address of MN 130. This tunnel packet is further encapsulated via an outer packet 682 and is sent to the care-of address of MR 210.

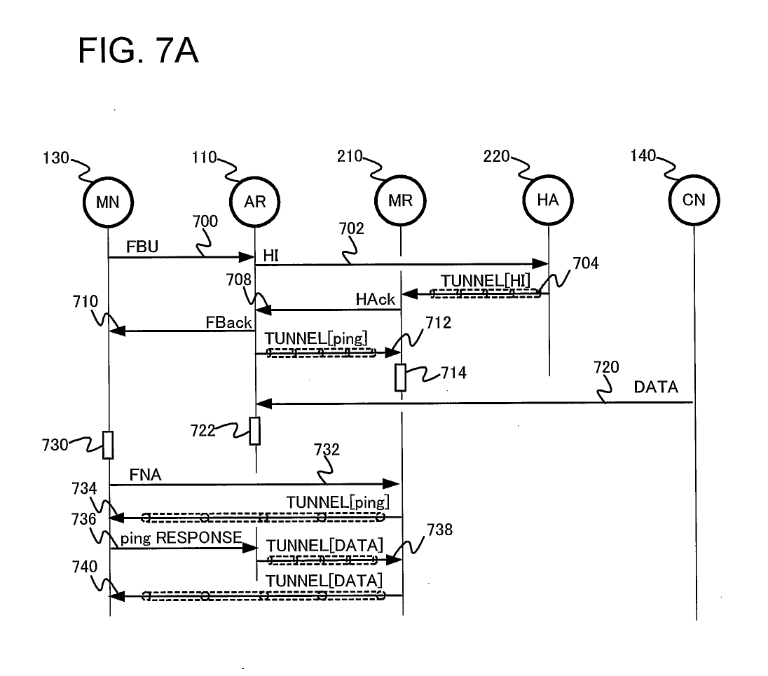

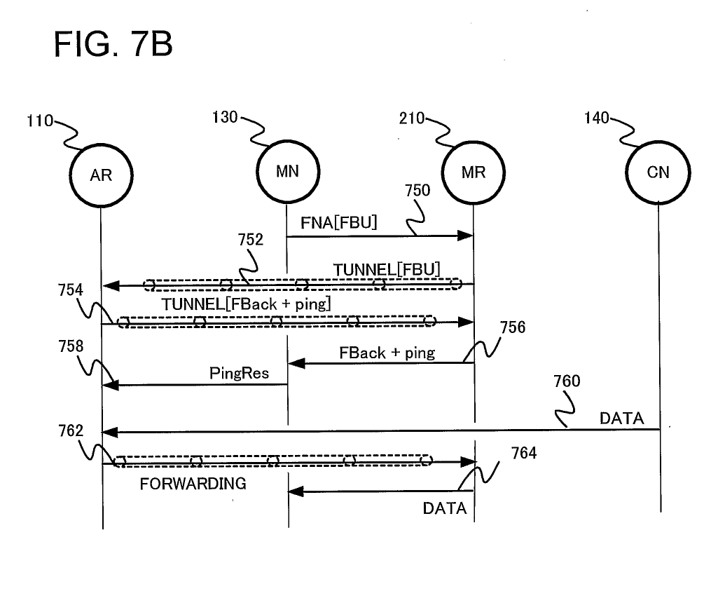

In the aspect of the present invention as described above, description has been given on a more efficient fast handover method. In this fast handover method, a previous access router (old access router) must match the standard route optimization as prescribed in the mobile IPv6. Further, if it is possible to change the previous access router (the old access router) so that more functions will be provided, it is possible to reduce the number of necessary messages. In the following, description will be given on an aspect in the preferred embodiment of the present invention by referring to FIG. 7A and FIG. 7B.

FIG. 7A shows a case where MN 130 performs predictive fast handover. When MN 130 detects an eminent handover, it sends a FBU message 700 to the current access router AR 110. Upon receipt of the FBU message 700, AR 110 sends a HI message 702 to MN 210. It is desirable that marking is given on the HI message 702 by some signal so that MR 210 can comprehend that AR 110 provides the new functions as explained here.

The HI message 702 sent from AR 110 is first intercepted by HA 220. HA 220 encapsulates the HI message 702 to a tunnel packet (tunnel [HI]) 704 and forwards it to actual position of MR 210. When this HI message 702 is received, MR 210 responds via a HAck message 708.

In this preferred operation mode, MR 210 does not perform tunneling of the HAck message 708 to its home agent HA 220, which performs the packet forwarding. Instead, by using its care-of address as the source address, the HAck message 708 is sent directly to AR 110. Upon receipt of this HAck message 708, AR 110 comprehends that MR 210 is actually positioned at the source address of the HAck message 708 and this is recorded. The packet to be sent to the new care-of address of MN 130 thereafter is sent by using this address. By sending a FBack message 710 to MN 130, AR 110 completes the procedure of the fast handover.

In a preferred embodiment of the invention, AR 110 may select the execution of the validity test of the care-of address of MR 210. To do this, AR 110 encapsulates via a tunnel packet (tunnel [ping]) 712 to the care-of address of MR 210 and sends a ping request message to the new care-of address of MN 130.

In this case, MN 130 does not yet change the point of attachment, and MR 210 performs buffering on the ping request message as shown in a process 714. AR 110 assumes that the care-of address of MR 210 is not tested until a ping response is received from MN 130 and does not use this care-of address. Therefore, in case it is assumed that CN 140 sends the data packet (data) 720 to the old care-of address of MN 130, AR 110 intercepts the packet but does not forward it. Instead, it performs buffering on this packet as shown in the process 722.

MN 130 sends a FNA message 732 to MR 210 when the process (process 730) of the point of attachment is finally performed. In so doing, it is indicated to MR 210 that MN 130 has completed the change of the point of attachment. As shown in a tunnel packet (tunnel [ping]) 734, MR 210 encapsulates the ping request message buffered previously and forwards it to MN 130. Upon receipt of the ping request message, MN 130 gives response via a ping response message 736. When the ping response message from MN 130 is received, AR 110 verifies the validity of the care-of address of MR 210. Then, MR 110 proceeds to forward the data processed by buffering previously to the new care-of address of MN 130. As shown by packets (tunnel [data]) 738 and 740 in FIG. 7A, the data are sent via the care-of address of MR 210.

FIG. 7B shows a case where MN 130 performs reactive fast handover. In this case, after MN 130 detects that the handover is carried out, MN 130 sends a FNA message (FNA [FBU]) 750 to the new access router MR 210. This FNA message 750 contains the encapsulated FBU message addressed to the old access router AR 110.

When the FNA message 750 is received, MR 210 forwards FBU message to AR 110 via a tunnel packet (tunnel [FBU]) 752. According to an aspect of the present invention, MR 210 directly sends the tunnel packet to AR 110 by using its care-of address. In so doing, the fact that MR 210 is attempting the optimized fast handover processing is indicated to AR 110. When this tunnel packet 752 is received, FBack message is prepared, which is to be sent back to the mobile node MN 130. At the same time, AR 110 embeds the ping request message in the FBack message in order to test the reachability to MN 130 via the care-of address of MR 210 and requests a ping response to the mobile node. This is indicated by a tunnel packet (tunnel [FBack+ping]) 754 sent from AR 110 to MR 210. When this packet is received, MR 210 decapsulates it and forwards a FBack message (FBack+ping) 756 to MN 130.

Then, MN 130 gives response by the ping response message 758. When AR 110 receives this ping response message, the care-of address of MR 210 is verified. When MR 110 receives a data packet (data) 760 sent to the old care-of address of MN 130 from CN 140, AR 110 forwards this data packet 760 via a tunnel packet 764 to be sent to the new care-of address of MN 130. This tunnel packet 764 is further encapsulated by an outer packet 762 and is sent to the care-of address of MR 210.

Those skilled in the art would easily understand that AR 110 and MN 130 can exchange some cryptographic token during the period when MN 130 is connected under the control of AR 110. In this case, AR 110 can protect the ping request message by adding security protection using the exchanged cryptographic token in FIG. 7A and FIG. 7B.

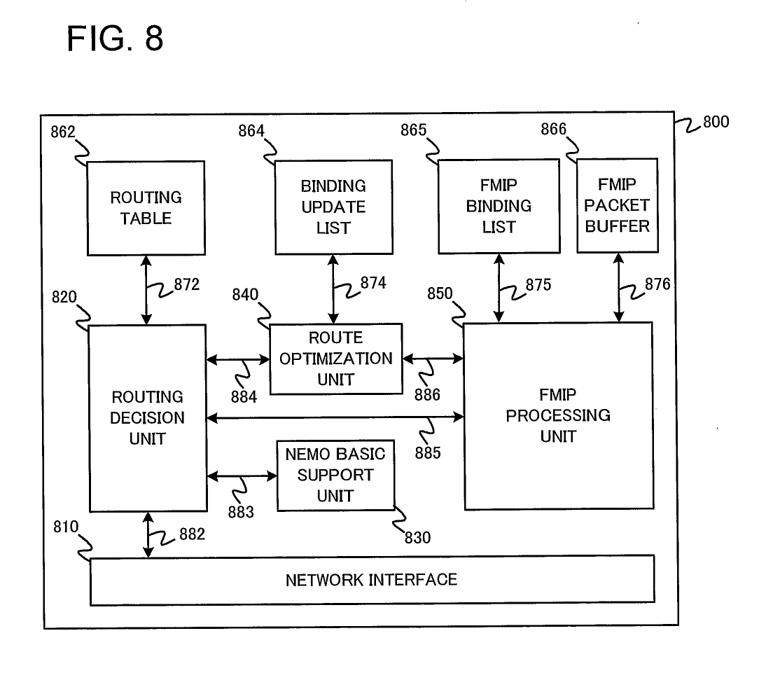

In order that the mobile router executes the operation as described above, according to a preferred embodiment of the present invention, a functional architecture of the mobile router as shown in FIG. 8 is provided, for instance.

A functional architecture 800 of the mobile router comprises one or more network interfaces 810, a routing decision unit 820, a NEMO basic support unit 830, a route optimization unit 840, a FMIP processing unit 850, and various types of information storage units (a routing table 862, a binding update list 864, a FMIP binding list 865, and a FMIP packet buffer 866).

The network interface 810 is a functional block, which contains all hardware and software necessary for performing communication with another node via some communication medium, by which a mobile node (a mobile router) can perform communication with another node. If the terminology known in the related technical field is used, the network interface 810 represents communication components of Layer 1 (physical layer) and Layer 2 (data link layer), a firmware, a driver, and a communication protocol.

The routing decision unit 820 handles all decision processes relating to the method to send packets. If the terminology known in the related technical field is used, the routing decision unit 820 represents the mounting of Layer 3 (network layer) protocol such as Internet Protocol version 4 or version 6.

The routing table 862 contains the rules to sum up the packet routing to support the decision-making at the routing decision unit 820. A list of routing entries is contained in the routing table 862. Each of the routing entries specifies address of the next hop node and/or network interface 810 according to the destination address or the source address or according to other information obtained from the transmitted packet.

The routing decision unit 820 can perform updating of the routing table 862 or the extraction of entry from the routing entry 862 by using a signal/data path 872. Also, the routing decision unit 820 can send and receive packets to and from an adequate network interface 810 by using a signal/data path 882.

The NEMO basic support unit 830 provides the NEMO basic support function as prescribed in the Non-Patent Document 3. In particular, the NEMO basic support unit 830 establishes and maintains a bi-directional tunnel to and from the home agent and performs processing on the packet to be sent via the bi-directional tunnel to and from the routing decision unit 820 by using a signal/data path 883.

The route optimization unit 840 carries out the route optimization procedure relating to mobility. The route optimization unit 840 performs return routability processing and sends a binding update message to and from the selected remote node and also establishes and maintains route optimization session to and from the remote node. The packets are delivered or received between the routing decision unit 820 and the route optimization unit 840 via a signal/data path 884. Also, for the purpose of maintaining status information relating to the route optimization session, the route optimization unit 840 reads the information from the binding update list 864 via a signal/data path 874 and stores the information.

The binding update list 864 is primarily used for such purpose that the mobile router stores a list of remote nodes to maintain the route optimization session. In so doing, the route optimization unit 840 can send the binding update message to these nodes when necessary.

The FMIP processing unit 850 fulfills the function to perform fast mobile IP handover to the mobile network node. The FMIP processing unit 850 performs, for instance, the processing of all signalings needed in the Non-Patent Document 2 such as FBU, HI, HAck messages. These messages are delivered from the routing decision unit 820 via a signal/data path 885. Further, the FMIP processing unit 850 sends FBack and HAck messages via the routing decision unit 820 by using the signal/data path 885. The binding of the old care-of address and the new care-of address of the mobile node is stored in the FMIP binding list 865. Further, it is desirable that the FMIP processing unit 850 stores related information such as the information as to whether the route optimization is used or not when packets are forwarded to the mobile node.

When a mobile router receives a packet address to a mobile node, which is not yet connected to the mobile network, the FMIP processing unit 850 stores the packet in the FMIP packet buffer 866. Also, when the FNA message is received from the mobile node, the FMIP processing unit 850 extracts a packet processed by buffering and to be forwarded to the mobile node from the FMIP packet buffer 866.

A signal/data path 876 is used for the communication between the FMIP processing unit 860 and the binding list 865 of FMIP. The signal data path 876 is used for the communication between the FMIP processing unit 850 and the FMIP packet buffer 866.

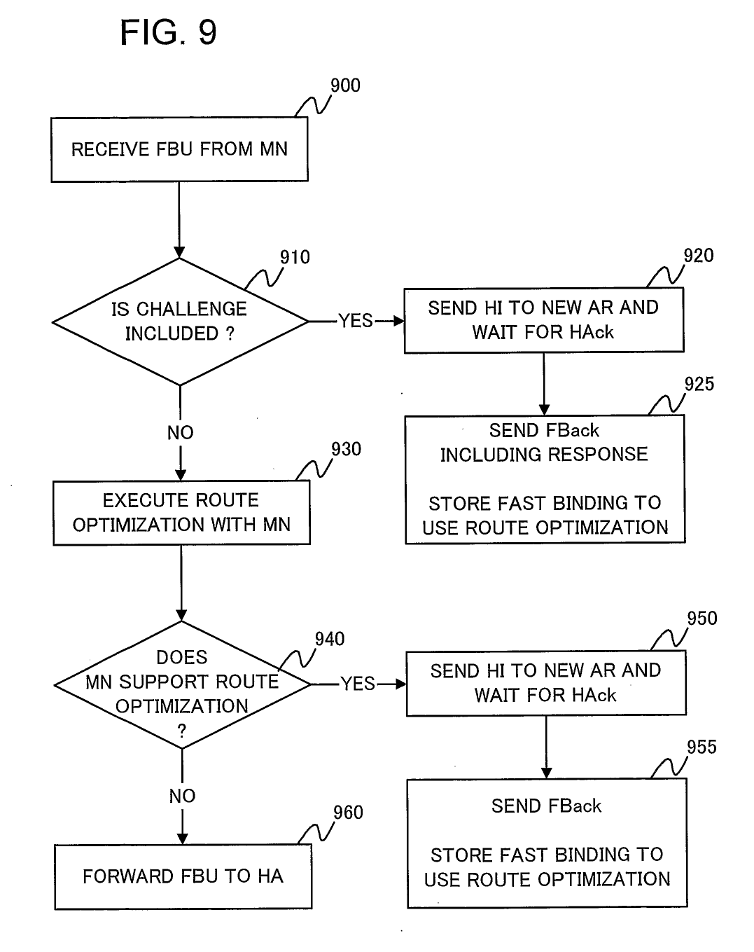

The FMIP processing unit 850 is a unit to fulfill main functions provided by the present invention. In addition to the mounting of the functions necessary for operation of the fast mobile IP as described in the non-Patent Document 2, the present invention prescribes several types of optimization processing. FIG. 9 to FIG. 11 each represents several new operations, which are preferably provided by the FMIP processing unit 850 of the mobile router.

FIG. 9 is a flow chart relating to the processing, which is required when the mobile router receives the FBU message from the mobile node. In this case, a transmission side mobile node is positioned away from the mobile network and it is shown that the FMIP binding is to be set up on the old care-of address containing a mobile network prefix and the new care-of address obtained at other site.

When the FBU message is received from the mobile node in Step 900, the mobile router checks whether a challenge (or an encrypted challenge) is embedded or not in the FBU message as shown in Step 910. If the encrypted challenge is embedded in the FBU message, the mobile router must perform the optimized fast handover operation such as the operation explained in connection with FIG. 4. For this reason, the mobile router first advances to Step 920, sends the HI message to the new access router and waits for a HAck message.

When the HAck message is received, Step 925 is taken, and the mobile router sends back a FBack message to the mobile node. The FBack message contains an adequate response to the challenge included in the FBU message. The mobile router stores the binding (fast binding) of the care-of address of the mobile node into the FMIP binding list 865, and it is marked that optimization should be performed on this binding.

On the other hand, in case the challenge is not contained in the BU message received in Step 910, it advances to Step 930, and the mobile router attempts to perform route optimization with the mobile node. Here, if MN supports the route optimization and the route optimization has been successfully performed (Step 940), Step 950 and Step 955 are taken. In Step 950, the mobile router sends a HI message to the new access router and waits for a response by the HAck message. Upon receipt of the HAck message, Step 955 is taken. The mobile router sends back the FBack message to the mobile node and stores binding (fast binding) of the care-of address of the mobile node in the FMIP binding list 865. On this binding, too, similarly to Step 925, the mobile router puts marking that optimization should be performed on this binding.

On the other hand, if the mobile node does not support the route optimization, the mobile router performs operation as shown in FIG. 5, for instance. In this case, as shown in Step 960, the mobile router forwards the FBU message merely to the home agent.

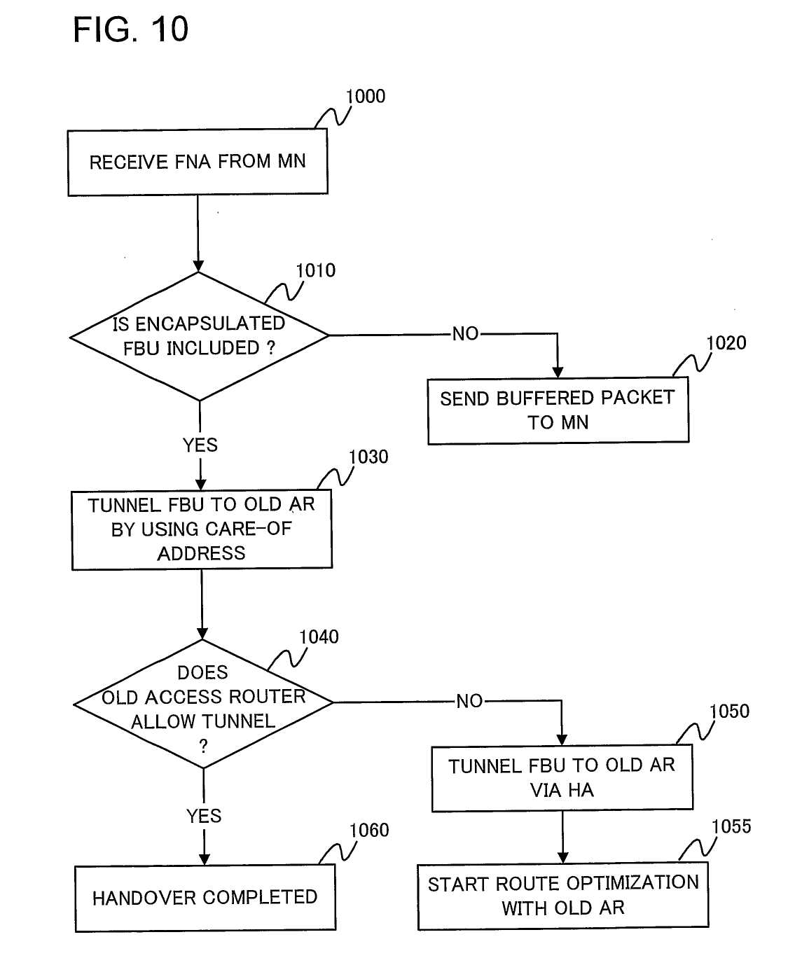

FIG. 10 is a flow chart of the processing of the FNA message received, which is preferably to be used by the mobile router. When the FNA message is received from the mobile node in Step 1000, the mobile router checks whether the FBU message is encapsulated in the FNA message or not in Step 1010. If the FBU message is not encapsulated in the FNA message, it advances to Step 1020. The mobile router scans the FMIP packet buffer 866 and sends a packet with buffering to the mobile node. In so doing, the handover procedure is completed.

On the other hand, in case the FBU message is encapsulated in the FNA message, Step 1030 is taken, and this FBU message is tunneled to the old access router via an outer tunnel, which uses the care-of address of the mobile router as the source address. This corresponds to the case where the operation shown in FIG. 7B is used.

If the old access router allows this tunnel, it means that this old access router recognizes the care-of address of the mobile router as a relay address for reaching the mobile node. Specifically, if the tunnel is allowed by the old access router in Step 1040, the handover procedure is completed in Step 1060.

On the other hand, if the old access router does not allow the tunnel in Step 1040, the mobile router must tunnel the FBU message to the old access router via the home agent as shown in Step 1050. As shown in Step 1055, the mobile router may carry out the route optimization between the old access router and the mobile router.

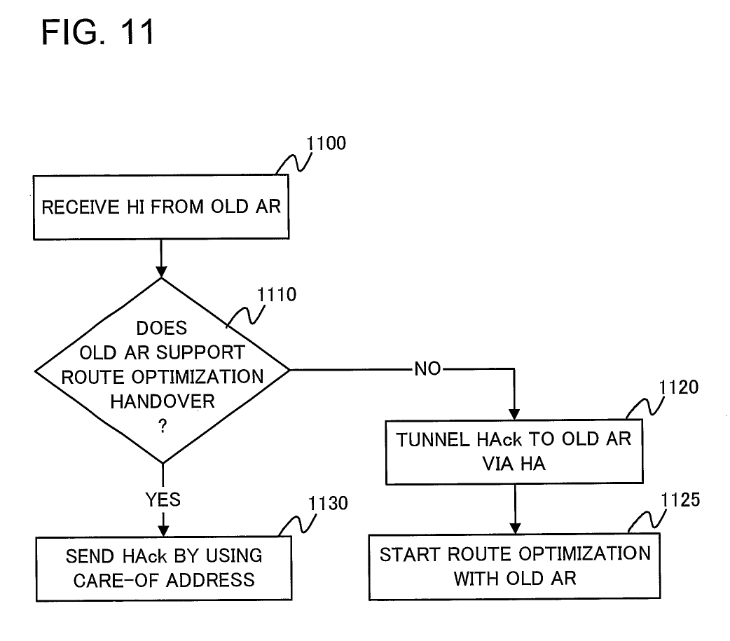

FIG. 11 is a flow chart, which is preferably used by the mobile router in order to process the HI message as received from the old access router. When the HI message is received in Step 1100, the mobile router checks whether the supporting of the optimized handover by the old access router is indicated in the HI message or not in Step 1110.

In case it is indicated in the HI message that the old access router supports the optimization, Step 1130 is taken, and the mobile router sends a HAck message to the old access router by using the care-of address as the source address. On the other hand, if nothing is indicated in the HI message, the mobile router must send the HAck message via a bi-directional tunnel established between the home agent and the mobile router as shown in 1120. Also, the mobile router may execute the route optimization to and from the old access router as shown in Step 1125.

According to another preferred embodiment of the invention, there is a case where the mobile router is in such a situation that a visiting mobile node frequently moves inside and outside of the mobile network. One example of such scenario is a network of a train. In this case, the mobile router is positioned in passenger car of a train so that commuters can gain access to Internet.

In case the fast handover is applied, a previous access router can determine the address of a new access router from the new care-of address of the mobile node according to the current practice. Normally, this means that the access routers are placed under the same management and control as closely set to each other. The present invention can also be applied to such scenario. For instance, by taking an example on the network of a train, the mobile router can be disposed by an operating manager of the train. Therefore, fixed access routers at a station of the train or a mobile access router on the train are placed under the management by the same management company. However, those skilled in the art would easily understand that the present invention can be utilized even when the mobile router and the access router are under the management by the different management companies, if the means to obtain the address of the router from the care-of address is present in the access router (e.g. the means to set up a certain bit length as network prefix and to acquire the address of the router relating to the network prefix by adding a predetermined bit pattern behind the network prefix).

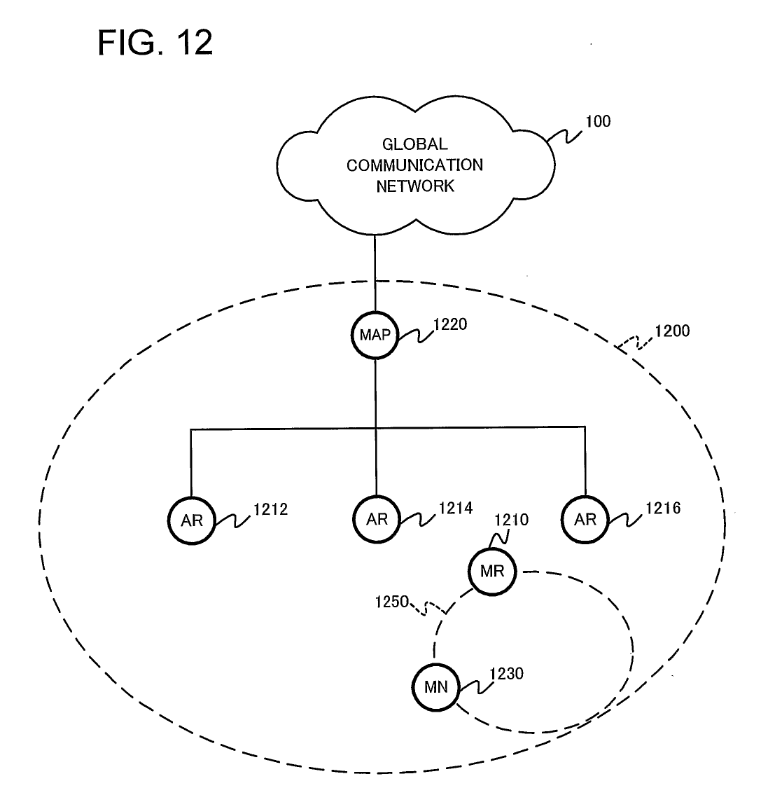

In another preferred embodiment of the invention, the field of local mobility management can be cited. For instance, this can be applied in the network of the train as described above, and it is shown in FIG. 12. In this case, an access network domain 1200 is connected to a global communication network 100 such as Internet. In the access network domain 1200, there are arranged a plurality of access routers 1212, 1214 and 1216. By these access routers 1212, 1214 and 1216, the mobile node can gain access to the global communication network 100. Also, there may be more than one mobile routers, which provide the mobile network 1250 where the mobile node can be connected.

The local mobility management is provided in the access network domain 1200 so that the mobile node moving in the access network domain 1200 (e.g. MN 1230) has no need to change the address even when it may be switched over to any access router (or mobile router) in the access network domain 1200. For instance, this can be accomplished when the mobility anchor point (MAP) 1220 is provided in the access network domain 1200.

The MAP 1220 fulfills the function as a home agent of the mobile node in the access network domain 1200. Each access router executes binding update to MAP 1200 in place of the mobile node. As a result, a mobile node MN 1230 should merely have a global care-of address, and it can be reached by this global address at any point in the access network domain 1200.

When the mobile node is connected to the access router, each access router assigns local care-of address, and the binding of global and local care-of address is registered to MAP 1220. In so doing, a packet sent to the global care-of address of MN 1230 is tunneled to the access router, to which MN 1230 is currently connected. As described above, local mobility management can now be realized.

In the arrangement as described above, the fast handover can be performed between the access routers 1212, 1214 and 1216 and the mobile router 1210. The present invention can be applied when the handover is further optimized in the access-network domain 1200.

In such case, the binding and the assignment of local care-of address are transparent to the mobile node. It would be apparent to those skilled in the art that the operation to be executed by the mobile node according to the present invention should be carried out by an access router, which fulfills the function as a proxy of the mobile node. Additionally, it should be obvious to a person skilled in the relevant art that the other terminologies may be used. For instance, the mobility anchor point is also known as a local mobility anchor, and the access router performing as a proxy of the mobile node is also known as a mobility access gateway.

In the above, the present invention has been described and shown by assuming the most practical and the most preferred embodiments, while it would be obvious to those skilled in the art that various changes can be made as far as the details such as arrangement and parameters are not deviated from the technical scope and spirit of the present invention.

Each of the functional blocks used in the description of the preferred embodiments of the invention can be realized as Large Scale Integration (LSI), which is typically represented by integrated circuit. These may be produced individually as one chip or may be produced in one chip including a part or all. Here, it is referred as LSI, while it may be called IC (Integrated Circuit), system LSI, super LSI, or ultra LSI, depending the difference in the degree of integration.

The method of integrated circuit is not limited to LSI, and it may be realized by a special-purpose circuit or a general-purpose processor. After manufacturing LSI, FPGA (Field Programmable Gate Array), which can be programmed after the manufacture of LSI, or a reconfigurable processor, in which connection or setting of circuit cells inside the LSI can be reconfigured, may be used.

Further, if a new technique of circuit integration to replace LSI may emerge with the progress of semiconductor technique or other technique derived from it, the functional blocks may be integrated by using such technique. For instance, the adaptation of biotechnology is one of such possibilities.

### INDUSTRIAL APPLICABILITY

The present invention provides the effects that inefficient and redundant routes can be reduced, which may occur when the fast handover is applied in network mobility and which may cause delay. The new technique can be applied in the communication field in the packet-switched data communication network.

1. A communication system including a mobile router, said mobile router having a home address managed by a predetermined home agent and a care-of address depending on moving position, said mobile router implementing a mobility function with a mobile network where a mobile node can connect under the control, and said mobile router being capable of fulfilling function as an access router of said mobile node to execute fast handover, wherein:
said mobile node is connected to said mobile router immediately before or immediately after said fast handover, and when a packet addressed to said mobile node is forwarded via two access routers connected immediately before or immediately after said fast handover including said mobile router, said packet is forwarded so that said packet does not pass through a tunnel between said mobile router and said predetermined home agent of said mobile router.

2. A mobile router having a home address managed by a predetermined home agent and a care-of address depending on moving position, said mobile router implementing a mobility function with a mobile network where a mobile node can connect under the control, and said mobile router being capable of fulfilling function as an access router of said mobile node to execute fast handover, wherein said mobile router comprises:
means for clarifying the validity of said care-of address of said mobile router to said mobile node in said mobile network; and
means for using own care-of address as a source address before forwarding a packet to said mobile node when said mobile node performs said fast handover to another access network from said mobile network.

3. The mobile router according to claim 2, wherein said means for clarifying the validity of said care-of address is so arranged that route optimization procedure is carried out to and from said mobile node in said mobile network.

4. The mobile router according to claim 2, wherein said means for clarifying the validity of said care-of address is so arranged that the validity of said care-of address is clarified to said mobile node, which sends a fast binding update message in said fast handover.

5. The mobile router according to claim 2, wherein said means for clarifying the validity of said care-of address is so arranged that said mobile node for clarifying the validity of said care-of address is selected.

6. The mobile router according to claim 2, wherein said means for clarifying the validity of said care-of address is so arranged that said care-of address is inserted in a message to be notified to said mobile network from said mobile router.

7. The mobile router according to claim 2, wherein said means for clarifying the validity of said care-of address is so arranged that encrypted information is exchanged to and from said mobile node in said mobile network in order to verify the validity of said care-of address.

8. A mobile router having a home address managed by a predetermined home agent and a care-of address depending on moving position, said mobile router implementing a mobility function with a mobile network where a mobile node can connect under the control, and said mobile router being capable of fulfilling function as an access router of said mobile node to execute fast handover, wherein said mobile router comprises:
means for clarifying the validity of said care-of address owned by said mobile router itself to an access router, to which said mobile node has been connected before said fast handover; and
means for using own care-of address as a source address when a packet addressed to said mobile node is forwarded in case said mobile node performs said fast handover to said mobile network from another access network under management of said access router, to which said mobile node has been connected before said fast handover.

9. The mobile router according to claim 8, wherein said means for clarifying the validity of said care-of address is so arranged that route optimization procedure is carried out to and from said access router, to which said mobile node has been connected before said fast handover.

10. The mobile router according to claim 8, wherein said means for clarifying the validity of said care-of address is so arranged that the validity of said care-of address is clarified to said access router sending said handover initiation message when the handover initiation message in said fast handover is received.

11. The mobile router according to claim 8, wherein said means for clarifying the validity of said care-of address is so arranged that the validity of said care-of address is clarified to said access router where said mobile node sending said fast neighbor advertisement message has been connected before said fast handover when a fast neighbor advertisement message in said fast handover is received.

12. The mobile router according to claim 8, wherein said means for clarifying the validity of said care-of address is so arranged that a predetermined message is exchanged to and from said access router where said mobile node has been connected before said fast handover in order to verify the validity of said care-of address.

13. A home agent managing a home address and a care-of address of a mobile router, said mobile router implementing a mobility function with a mobile network where a mobile node can connect under the control, and said mobile router being capable of fulfilling function as an access router of said mobile node to execute fast handover, wherein said home agent comprises:
means for storing a binding of a care-of address of said mobile node under the condition where said mobile node is connected to said mobile network and a care-of address of said mobile node in a new access network where said mobile node is connected by said fast handover; and
means for forwarding a packet, which is addressed to the care-of address of said mobile node under the condition where said mobile node is connected to said mobile network, said packet to be forwarded to the care-of address of said mobile node in said new access network.
